(19) United States
(12) Patent Application Publication
(10) Pub. No.: US 2012/0229108 A1
(43) Pub. Date: Sep. 13, 2012

(54) Reduced power consumption for boost converter

(75) Inventors: Karl Edward Sprentall, Scottsdale, AZ (US); Douglas James Anderson, Queen Creek, AZ (US)

(73) Assignee: Rogers Corporation, Rogers, CT (US)

(21) Appl. No.: 12/932,884

(22) Filed: Mar. 9, 2011

(51) Int. Cl. G05F 1/10

(52) U.S. Cl. 323/282

(57) ABSTRACT

A signal for controlling output voltage from the driver is modulated by the input signal to the driver, whereby the output voltage tracks the input signal, matching power to demand. The output storage capacitor can be reduced in size because the amount of energy that needs to be stored is reduced. In addition, feedback transistors are paired on the same substrate and cause opposite changes in response to changes in temperature, thereby automatically compensating for changes in temperature without the use of additional components.

This invention relates to a battery powered driver and, in particular, to a driver in which power consumption is significantly reduced by supplying power only on demand under hardware control.

### CROSS-REFERENCE TO RELATED APPLICATION

This application relates to application Ser. No. 12/592,353, filed Nov. 24, 2009, entitled Driver for Piezoelectric Actuator and assigned to the assignee of this invention. The entire contents of said application are incorporated by reference into this application.

### BACKGROUND

A piezoelectric actuator requires high voltage, greater than typical battery voltages of 1.5 to 12.6 volts. A “high” voltage is 20-200 volts, with 100-120 volts currently being a typical drive voltage. Some line driven power supplies for actuators provide as much as 1000 volts. Producing high voltage from a battery is more difficult than producing high voltage from a power line.

A voltage boost converter can be used to convert the low voltage from a battery to a higher voltage for the driver. In a boost converter, the energy stored in an inductor is supplied to a capacitor as pulses of current at high voltage.

FIG. 1 is a schematic of a circuit including a known boost converter; e.g. see U.S. Pat. No. 3,913,000 (Cardwell, Jr.) or U.S. Pat. No. 4,527,096 (Kindlmann). Inductor 11 and transistor 12 are connected in series between supply 13 and ground or common. When transistor 12 turns on (conducts), current flows through inductor 11, storing energy in the magnetic field generated by the inductor. Current through inductor 11 increases quickly, depending upon battery voltage, inductance, internal resistances, and the on-resistance of transistor 12. When transistor 12 shuts off, the magnetic field collapses at a rate determined by the turn-off characteristic of transistor 12. The rate of collapse is quite rapid, much more rapid than the rate at which the field increases. The voltage across inductor 11 is proportional to the rate at which the field collapses. Voltages of one hundred volts or more are possible. Thus, a low voltage is converted into a high voltage by the boost converter.

When transistor 12 shuts off, the voltage at junction 15 is substantially higher than the voltage on capacitor 14 and current flows through diode 16, which is forward biased. Each pulse of current charges capacitor 14 a little and the charge on the capacitor increases incrementally. At some point, the voltage on capacitor 14 will be greater than the supply voltage. Diode 16 prevents current from flowing to supply 13 from capacitor 14. The voltage on capacitor 14 is the supply voltage for other components, such as amplifier 21.

As used herein, “supply” provides the operating power for a device, as opposed to “bias” that provides control or offset. For example, it is known in the memory art to provide a boost converter for biasing the gate of a field effect transistor; U.S. Pat. No. 4,660,177 (O'Conner).

The output of amplifier 21 is coupled to piezoelectric actuator 22. The input to amplifier 21 can receive an alternating current signal, for bi-directional movement, or a direct current signal, for unidirectional movement or as half of a complementary drive (two amplifiers, one for each polarity, coupled to opposite terminals of piezoelectric actuator 22). In a complementary drive, the absolute magnitudes of the boosted voltages are greater than the absolute magnitude of the battery voltage. A complementary drive can use half the high voltage (or be provided with twice the high voltage) of a single drive but requires two boost converters.

It is known in the art to maintain power to a load by varying frequency and pulse width; see U.S. Pat. No. 4,914,396 (Berthiaume). It is known in the art to maintain power to a load by monitoring the supply voltage and adjusting pulse width to compensate for changes; see U.S. Pat. No. 5,703,473 (Phillips et al.).

In the prior art, a driver operates at full capacity to provide enough power for the peak in each half cycle of a sine wave, even though less power is needed during the rest of the sine wave. To conserve power when the piezoelectric device is not being used, the driver is often turned off in software. This can cause a noticeable delay in response when power becomes necessary. There is a small but inherent delay in software and a longer delay while capacitors charge. Capacitors cannot be made smaller arbitrarily to reduce delay because this also reduces output power. A delay of more than approximately 0.2 seconds is easily noticed by a typical user.

Any device that consumes power generates heat, which increases the temperature of the components. Changes in temperature often cause changes in the characteristics of electrical components. Adding temperature compensation to a circuit typically increases the cost of a device considerably and is not done unless precision is required, e.g. as in high resolution test circuits. If temperature compensation could be obtained without additional components, such would be most welcome in the art.

Reducing the size or capacitance of storage capacitors can, without other changes, reduce power output. On the other hand, power consumption can be reduced if the amount of energy being stored is reduced by reducing the size of storage capacitors. Also, start-up time can be reduced by reducing the size of storage capacitors. If start-up time can be reduced sufficiently, a designer has the option to shut the driver off in software, thereby reducing power consumption even more, without worrying about excessive delays.

In view of the foregoing, it is therefore an object of the invention to reduce the power consumption of a piezoelectric driver powered by a low voltage, external supply.

Another object of the invention is to provide temperature compensation without increasing the cost of the driver.

A further object of the invention is to decrease power consumption by reducing the size of the output storage capacitor.

Another object of the invention is to reduce the start-up time of a driver for piezoelectric devices.

### SUMMARY OF THE INVENTION

The foregoing objects are achieved in the invention in which a signal for controlling output voltage is modulated by the input signal to the driver, whereby the output voltage tracks the input signal, matching power to demand. The output storage capacitor can be reduced in size because the amount of energy that needs to be stored is reduced. In addition, feedback transistors are paired on the same substrate and cause opposite changes in response to changes in temperature, thereby automatically compensating for changes in temperature without the use of additional components.

### BRIEF DESCRIPTION OF THE DRAWINGS

A more complete understanding of the invention can be obtained by considering the following detailed description in conjunction with the accompanying drawings, in which:

FIG. 1 is a schematic of a driver, constructed in accordance with the prior art, coupled to a piezoelectric actuator;

FIG. 2 is a perspective view of an electronic device having a display and a keypad, either or both of which include a piezoelectric actuator;

FIG. 3 is a schematic of a driver, constructed in accordance with the invention, coupled to a piezoelectric actuator;

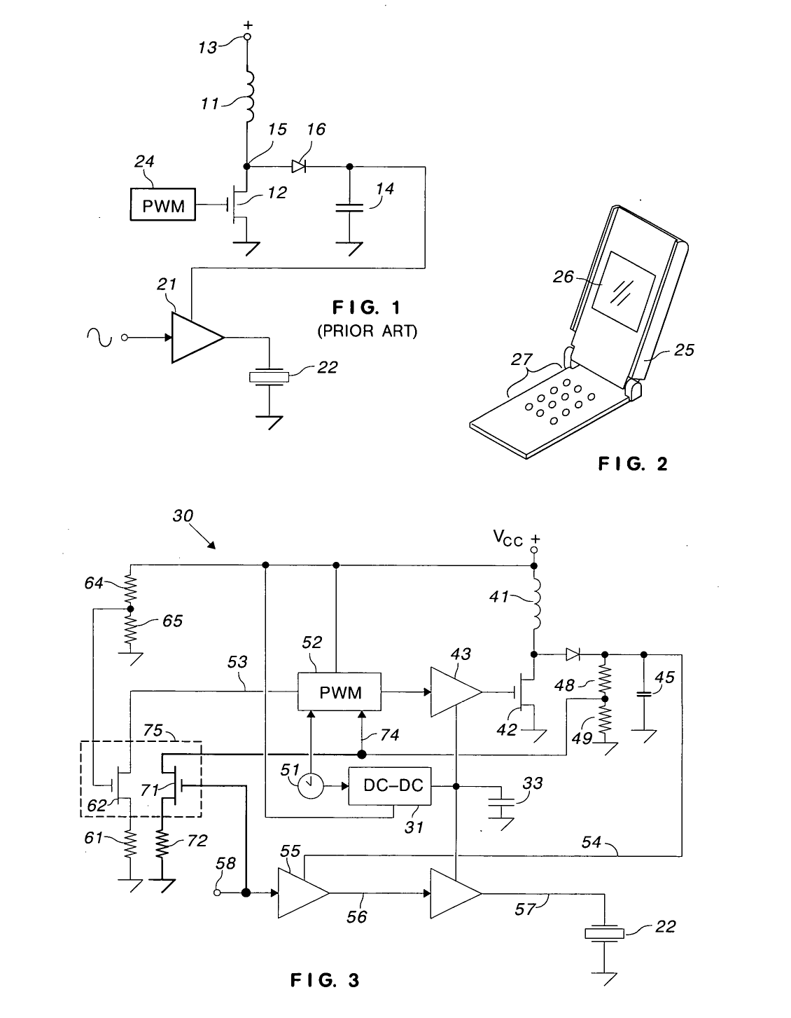

### DETAILED DESCRIPTION OF THE INVENTION

FIG. 2 illustrates electronic device 25 including display 26 and keypad 27. Either the display or the keypad, or both, can be provided with a piezoelectric device (not shown) for providing tactile feedback when a key or a portion of the display is depressed slightly. Devices for providing feedback are known in the art. As described above, such devices can be single layer or multi-layer and unidirectional or bi-directional.

FIG. 3 is a block diagram of a preferred embodiment of the invention in which a transistor operating in a linear range acts as a variable resistance or inverting amplifier. Inductor 41 is connected in series with transistor 42 between supply and ground. The gate of transistor 42 is coupled to buffer amplifier 43.

Driver 30 includes low voltage boost circuit 31 for generating a local supply voltage on the die. Circuit 31 preferably uses capacitive pump, known per se in the art, storing energy on external capacitor 33. The output from boost circuit 31 is, for example, five volts, for powering buffer amplifier 43. By providing an internal supply voltage that is higher than V_{CC}, the battery voltage, one can drive the gate of switching transistor 42 at a higher voltage, thereby increasing the efficiency of the high voltage boost converter including inductor 41 and transistor 42. A voltage divider including resistor 48 and resistor 49 is coupled in parallel with output capacitor 45 to provide feedback for controlling the voltage on capacitor 45.

Clock 51, which can include an oscillator and dividers or counters (not shown), is coupled to pulse width modulator 52 and circuit 31, which need not operate at the same frequency. A clock rate greater than 100 kHz. or higher is preferred for pulse width modulator 52. A clock rate in this range of frequencies enables one to use inductors that are physically small and less expensive. Current increases with inductance and decreases with frequency. The clock signal into circuit 31 is preferably lower in frequency than the clock signal into pulse width modulator 52; e.g. one half or one fourth.

Pulse width modulator circuit 52 can be analog or digital. An analog circuit uses a ramp generator and a comparator. The ramp voltage is compared with a fixed voltage to determine pulse width. A digital circuit uses a shift register in which the bit pattern stored in the register determines pulse width. Both constructions are long known in the art. A digital circuit is preferred.

Input amplifier 55 and output amplifier 56 are powered by the supply voltage on capacitor 45. That is, line 54 represents an internal rail for powering some circuits. Output 57 of amplifier 56 is coupled to piezoelectric actuator 22. There can be more than two amplifying stages between input 58 and output 57.

As described thus far, driver 30 is known in the art. Input 53 is a control input of pulse width modulator 52. Duty cycle is controlled by the resistance between input 53 and ground or common.

Transistor 62 is coupled in series with resistor 61 between input 53 and ground. The control input of transistor 62 is coupled to the junction of resistor 64 and resistor 65, which form a voltage divider between supply (V_{CC}) and ground.

Transistor 62 inverts the direction of change of the supply voltage. If the supply voltage decreases, as the output voltage of a battery would over time, the bias voltage applied to the control input of transistor 62 also decreases. When the bias voltage decreases, the resistance of transistor 62 increases. When the resistance increases, the duty cycle of the pulse width from modulator 52 increases, thereby maintaining output voltage at a desired value. Thus, a range of supply voltages will produce substantially the same output voltage.

In accordance with one aspect of the invention, transistor 71 and resistor 72 are coupled in series with each other and in parallel with resistor 49. The control input of transistor 71 is coupled to input 58, which received the input signal to driver 30; e.g., 3.62 volts at 250 Hz. The input signal causes transistor 71 to vary the feedback voltage to pulse width modulator 52.

As the voltage on input 58 increases, the resistance of transistor 71 decreases and the voltage on input 74 to pulse width modulator 52 decreases. The decrease in feedback voltage causes pulse width modulator 52 to increase output voltage. Similarly, when the voltage on input 58 decreases, the resistance of transistor 71 increases and the voltage on input 74 to pulse width modulator 52 increases. The increase in feedback voltage causes pulse width modulator 52 to decrease output voltage. Thus, the voltage on rail 54 follows the variations in the input signal to the driver.

In accordance with another aspect of the invention, the size (capacitance) of capacitor 45 can be reduced compared with circuits of the prior art because energy is provided on demand, not available at all times. In one embodiment of the invention, the storage capacitance was reduced from 100 nf to 10 nf. This significantly reduces start-up time, e.g. from 20 milliseconds to 3-4 milliseconds. Because the start-up time is reduced, a system designer has greater flexibility in designing a device such as illustrated in FIG. 2, including the ability to turn off driver 30 in software.

In accordance with another aspect of the invention, transistors 62 and 71 are on the same die, as indicated by dashed rectangle 75. A change in temperature that increases the resistance of transistor 62 also increases the resistance of transistor 71. However, the increases in resistance oppositely affect output voltage, thereby providing temperature compensation without additional components.

The invention thus reduces the power consumption and start-up time of a piezoelectric driver. In one embodiment of the invention, power consumption was reduced by fifty percent and start-up time was reduced by eighty percent. A circuit constructed in accordance with the invention further provides temperature compensation without increasing the cost of the driver.

Having thus described the invention, it will be apparent to those of skill in the art that various modifications can be made within the scope of the invention. For example, functionally, it does not matter if the positions of transistor 71 and resistor 72 are reversed. Numerical values are by way of example only. A digital signal can be applied to input 58 and filtered in a low pass filter (not shown) to provide a half-wave or full wave, approximately sinusoidal signal. Pulse width can be varied by changing frequency or by changing duty cycle. One can use parallel, voltage sensitive switches, e.g. SCR's each in series with a resistor, having their control inputs coupled to input 58 for causing the rail voltage to follow variations in the input voltage. A microcontroller, with analog to digital (A/D) and digital to analog (D/A) conversion circuits, can be programmed to cause the rail voltage to follow variations in the input voltage. A moving average of data can be used to control pulse width and to adjust timing (phase relationship) between the rail voltage and the input signal.

What is claimed as the invention is:

1. A battery powered driver including a boost converter, a pulse width modulator controlling the boost converter, a storage capacitor coupled to the output of said boost converter, wherein the voltage on said storage capacitor is a rail voltage, said driver characterized in that
the driver includes a feedback loop for varying the rail voltage in accordance with an input signal by varying the width of the pulses from said pulse width modulator.

2. The driver as set forth in claim 1 wherein the duty cycle of said pulses is varied.

3. A battery powered driver including a boost converter, a pulse width modulator controlling the boost converter, a storage capacitor coupled to the output of said boost converter, a first resistor and a second resistor connected in series with each other and in parallel with said storage capacitor, and an amplifier powered by the voltage on the storage capacitor, said amplifier having a control input, said driver characterized in that
the driver includes a first transistor coupled between common and the junction of the first resistor and the second resistor;
wherein said first transistor is biased in proportion the voltage on said control input, thereby varying output voltage according to demand and decreasing overall power consumption of the driver.

4. A battery powered driver as set forth in claim 3 and further including a second transistor coupled to said pulse width modulator for varying output power inversely in proportion to supply voltage.

5. A battery powered driver as set forth in claim 4 wherein the first transistor and the second transistor are on the same semiconductor die, thereby providing temperature compensation of output voltage from said driver.

6. A battery powered driver as set forth in claim 3 wherein said storage capacitor has a capacitance less than a value corresponding to a start-up time of ten milliseconds.

7. A battery powered driver as set forth in claim 3 wherein said storage capacitor has a capacitance less than a value corresponding to a start-up time of five milliseconds.

8. A method for operating a battery powered driver for piezoelectric devices, said driver including a boost converter and a pulse width modulator controlling the boost converter for providing a rail voltage, said method comprising the steps of:
controlling the duty cycle of the pulse width modulator in proportion to a variable input signal to the driver;
operating a driver for a piezoelectric device from said rail voltage.
